(19) United States
(12) Patent Application Publication
(10) Pub. No.: US 2014/0063787 A1
(43) Pub. Date: Mar. 6, 2014

(54) Liquid Crystal Device, Backlight Module, and Backplane

(71) Applicants: Chong Huang, Shenzhen (CN); Yu-chun Hsiao, Shenzhen (CN); Yi-cheng Kuo, Shenzhen (CN)

(72) Inventors: Chong Huang, Shenzhen (CN); Yu-chun Hsiao, Shenzhen (CN); Yi-cheng Kuo, Shenzhen (CN)

(73) Assignee: SHENZHEN CHINA STAR OPTOELECTRONICS TECHNOLOGY CO., LTD, Shenzhen, Guangdong (CN)

(21) Appl. No.: 13/641,408

(22) PCT Filed: Sep. 6, 2012
(86) PCT No.: PCT/CN2012/081049

§ 371 Date: Oct. 15, 2012

(30) Foreign Application Priority Data
Aug. 28, 2012 (CN) 201210310364.0

(51) Int. Cl. G02F 1/1335; G09F 13/04

(52) U.S. Cl. CPC G02F 1/133602; G09F 13/04
USPC 362/97.2; 362/97.1

(57) ABSTRACT

A backplane for a backlight module is disclosed. The backplane includes a light incident support for arranging a light source of the backlight module. The light incident support includes an aeration tank for dissipating heat generated from the light source, a sidewall and a connected bottom, wherein the light incident support is formed by extruded alumni. A liquid crystal device and a backlight module are also disclosed. The above backplane, backlight module and liquid crystal device may reduce the cost and enhance the heat dissipation performance.

### BACKGROUND OF THE INVENTION

1. Field of the Invention

Embodiments of the present disclosure relate to display technology, and more particularly to a liquid display device, the backlight module and the backplane thereof.

2. Discussion of the Related Art

Liquid crystal devices generally include backlight modules and liquid crystal panels that are stacked one on another, and backlight modules provide lights to the liquid crystal panels. LED is a typical point light source for backlight modules. Multiple LEDs are arranged on a surface of a print circuit board (PCB) as a single light source array to form the general light bar. When driven by the PCB, multiple LEDs emit lights so as to form a light bar. The emitting direction of the light bar is then directed by the light guiding plate (LGP) of the backlight module to obtain a uniform surface light source. As a great deal of heat may be generated due to the light source, corresponding heat dissipation device is thus needed.

Currently, the light sources are arranged on the PCB, and the metallic PCB contacts with the backplane so as to dissipate the heat. However, the heat dissipation method cannot transfer the heat to the backplane in an efficient way. In addition, the cost of the metallic PCB is high.

### SUMMARY

The object of the claimed invention is to provide a liquid crystal device, a backlight module, and a backplane to reduce the cost and enhance the heat dissipation performance at the same time.

In one aspect, a backplane for a backlight module includes a light incident support for arranging a light source of the backlight module. The light incident support includes an aeration tank for dissipating heat generated from the light source, a sidewall and a connected bottom. Wherein the light incident support is formed by extruded alumni.

Wherein the light source is arranged on an internal surface of the sidewall, and the raised aeration tank is formed on an outside surface of the sidewall.

Wherein the light source is arranged on an internal surface of the bottom, and the raised aeration tank is formed on an outside surface of the sidewall.

Wherein the aeration tank is hollow rectangular-shaped or hollow bow-shaped, four sides of the aeration tank form a cavity, and two sides of the aeration tank communicate with the air outside the aeration tank.

Wherein the backplane includes a plurality of supports including a left support, a right support, an up support, and a down support, and at least one of the support is the light incident support.

Wherein the heat dissipation materials are coated on the locations corresponding to the light source, or on the whole light incident support.

Wherein the heat dissipation materials are heat resistant paints or heat radiation materials, and the heat dissipation materials are coated on the light incident support by spraying or brushing.

In another aspect, a backlight module includes a backplane. The backplane includes a light incident support for arranging a light source of the backlight module. The light incident support includes an aeration tank for dissipating heat generated from the light source, a sidewall and a connected bottom. Wherein the light incident support is formed by extruded alumni.

Wherein the aeration tank is hollow rectangular-shaped or hollow bow-shaped, four sides of the aeration tank form a cavity, and two sides of the aeration tank communicate with the air outside the aeration tank.

In another aspect, a liquid crystal device includes the liquid crystal panel and the backlight module.

### BRIEF DESCRIPTION OF THE DRAWINGS

FIG. 1 is a schematic view of the light incident support in accordance with a first embodiment of the claimed invention.

FIG. 2 is a schematic view of the light incident support in accordance with a second embodiment of the claimed invention.

FIG. 3 is a schematic view of the backplane in accordance with one embodiment of the claimed invention.

FIG. 4 is an enlarged view of the section indicated by “A” of the backplane of FIG. 3.

### DETAILED DESCRIPTION OF THE EMBODIMENTS

Embodiments of the invention will now be described more fully hereinafter with reference to the accompanying drawings, in which embodiments of the invention are shown.

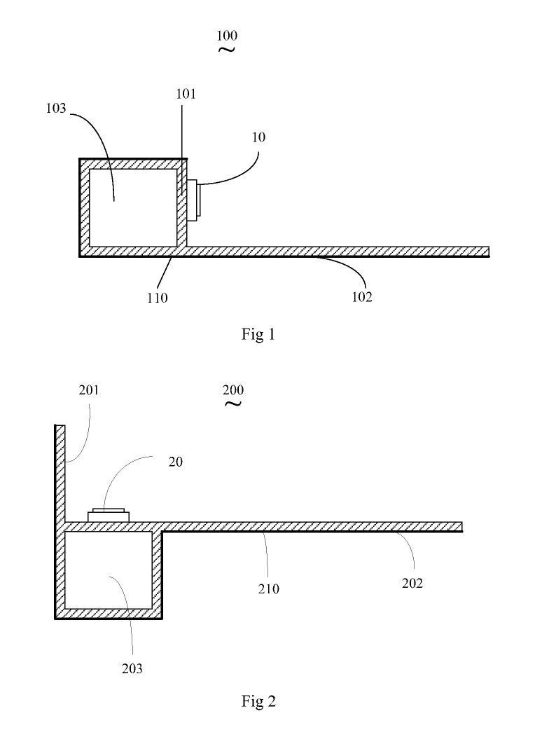

FIG. 1 is a schematic view of the light incident support in accordance with a first embodiment of the claimed invention, in which a light source 10 is shown. The light incident support 100 includes a sidewall 101, a bottom 102, and an aeration tank 103. The light incident support 100 is integrally formed by extruded alumni. In other embodiments, the light incident support 100 may be integrally formed by, but not limited to, electro-galvanized steel sheet.

In the embodiment, the light source 10 is a side light type, and the light source 10 is arranged on an internal surface of the sidewall 101. Specifically, the light source 10 may include a plurality of LED light strips.

The sidewall 101 connects with the bottom 102. The sidewall 101 is a heat centralized area. The outside surface of the sidewall 101, which is opposite to the internal surface of the sidewall 101, is coated with a heat dissipation layer 110 to enhance the heat dissipation efficiency of the sidewall 101. In the embodiment, preferably, the heat dissipation layer 110 is made by, but not limited to, heat resistant paints or heat radiation materials, or other materials with heat dissipation capability. Furthermore, the heat dissipation layer 110 may be applied to the whole outside surface of the light incident support 100 to enhance the heat dissipation efficiency. In one embodiment, the heat dissipation materials may be applied to the light incident support 100 by spraying or brushing.

The raised aeration tank 103 is formed on the outside surface of the sidewall 101. As shown in FIG. 1, four sides of the aeration tank 103 form a cavity. Also referring to FIG. 4, two sides of the aeration tank 103 may communicate with the air outside the aeration tank 103. During the heat dissipation process, the airs outside the aeration tank 103 may flow into the aeration tank 103 so as to enhance the heat dissipation efficiency of the aeration tank 103. In the embodiment, the aeration tank 103 may be hollow rectangular-shaped or hollow bow-shaped. In other embodiments, the aeration tank 103 may be tanks of other shapes only if the airs may flow between the aeration tank 103 and outside of the aeration tank 103.

In the embodiment, the light source is arranged on the sidewalls of the light incident support 100, and the aeration tank 103 is formed on the outside surface of the sidewall so that the cost is reduced and the heat dissipation efficiency is reduced.

FIG. 2 is a schematic view of the light incident support in accordance with a second embodiment of the claimed invention, in which the light source 20 is shown. The light incident support 200 includes a sidewall 201, a bottom 202, and an aeration tank 203. The light incident support 200 is integrally formed by extruded alumni. In other embodiments, the light incident support 200 may be integrally formed by, but not limited to, electro-galvanized steel sheet.

In the embodiment, the light source 20 is a direct light type, and the second support 20 is arranged on an internal surface of the bottom 202. Specifically, the light source 20 may include a plurality of LED light strips.

The bottom 202 connects with the sidewall 201. The bottom 202 is a heat centralized area. The outside surface of the bottom 202, which is opposite to the internal surface of the bottom 202, is coated with a heat dissipation layer 210 to enhance the heat dissipation efficiency of the sidewall 202. In the embodiment, preferably, the heat dissipation layer 210 is made by, but not limited to, heat resistant paints or heat radiation materials, or other materials with heat dissipation capability. Furthermore, the heat dissipation layer 210 may be applied to the whole outside surface of the light incident support 200 to enhance the heat dissipation efficiency. In one embodiment, the heat dissipation materials may be applied to the light incident support 200 by spraying or brushing.

The raised aeration tank 203 is formed on the outside surface of the bottom 202. As shown in FIG. 1, four sides of the aeration tank 103 form a cavity. Also referring to FIG. 4, two sides of the aeration tank 103 may communicate with the air outside the aeration tank 103. During the heat dissipation process, the airs outside the aeration tank 203 may flow into the aeration tank 203 so as to enhance the heat dissipation efficiency of the aeration tank 203. In the embodiment, the aeration tank 203 may be hollow rectangular-shaped or hollow bow-shaped. In other embodiments, the aeration tank 203 may be of other shapes only if the airs may flow between the aeration tank 203 and outside of the aeration tank 203.

In the embodiment, the light source is arranged on the bottoms of the light incident support, and the aeration tank is formed on the outside surface of the bottom so that the cost is reduced and the heat dissipation efficiency is reduced.

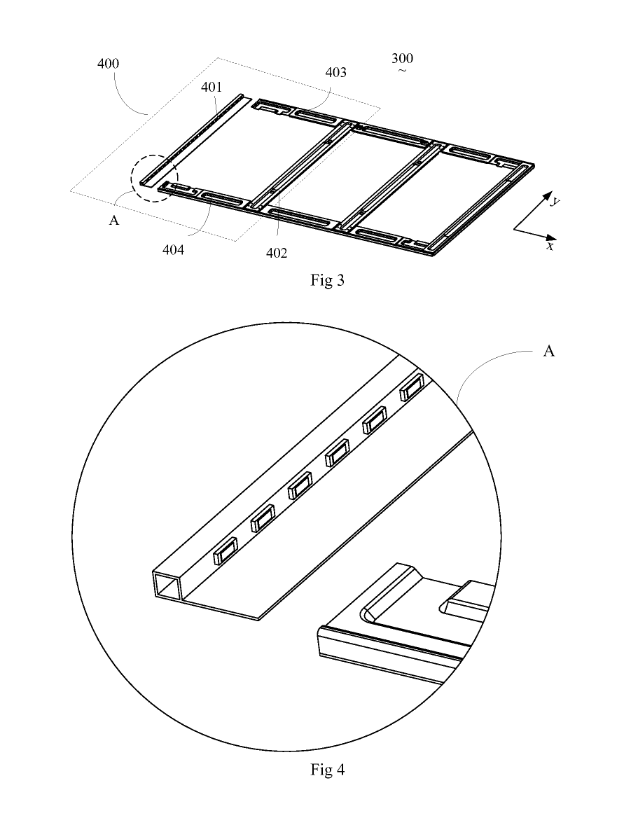

Referring to FIGS. 3 and 4. FIG. 3 is a schematic view of the backplane in accordance with one embodiment. FIG. 4 is an enlarged view of the section indicated by “A” of the backplane of FIG. 3. The backplane 300 includes a plurality of pieces 400. The structure of the backplane 300 will be described more fully hereinafter by introducing the piece 400. In order to illustrate the relationship between the components, the x-axis and the y-axis are indicated in FIG. 3.

The piece 400 includes a left support 401, a right support 402, an up support 403, and a down support 404. In the embodiment, as shown in FIG. 4, the left support 401 is a light incident support. In other embodiments, the right support 402, the up support 403, the down support 404 may be the light incident support according to the locations of the light source. In other embodiments, two or more than two of the above supports may be arranged to be the light incident support. It is understood that the heat dissipation layer should be applied to the light incident support accordingly so as to enhance the heat dissipation efficiency.

Furthermore, in the embodiment, the backplane 300 is assembled by the plurality of supports. Comparing to the integrally formed backplane, as the support is smaller, the heat dissipation materials only have to be coated on the corresponding light incident support. In this way, large-scale apparatus for fixing is thus not needed and cost is reduced.

In one embodiment, a backlight module includes the backplane disclosed in the above embodiments. The backplane includes a plurality of supports, and the light source is arranged on the light incident support. In addition, an aeration tank is arranged on the light incident support to reduce the cost and enhance the efficiency.

In addition, in one embodiment, a liquid crystal device includes a liquid crystal panel and the backlight module disclosed in the above embodiments.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backplane for a backlight module, comprising:
a light incident support for arranging a light source of the backlight module, the light incident support comprises an aeration tank for dissipating heat generated from the light source, a sidewall and a connected bottom; and
wherein the light incident support is formed by extruded alumni.

2. The backplane as claimed in claim 1, wherein the light source is arranged on an internal surface of the sidewall, and the raised aeration tank is formed on an outside surface of the sidewall.

3. The backplane as claimed in claim 1, wherein the light source is arranged on an internal surface of the bottom, and the raised aeration tank is formed on an outside surface of the sidewall.

4. The backplane as claimed in claim 3, wherein the aeration tank is hollow rectangular-shaped or hollow bow-shaped, four sides of the aeration tank form a cavity, and two sides of the aeration tank communicate with the air outside the aeration tank.

5. The backplane as claimed in claim 1, wherein the backplane comprises a plurality of supports comprising a left support, a right support, an up support, and a down support, and at least one of the support is the light incident support.

6. The backplane as claimed in claim 1, wherein the heat dissipation materials are coated on the locations corresponding to the light source, or on the whole light incident support.

7. The backplane as claimed in claim 6, wherein the heat dissipation materials are heat resistant paints or heat radiation materials, and the heat dissipation materials are coated on the light incident support by spraying or brushing.

8. A backlight module, comprising:
a backplane comprises a light incident support for arranging a light source of the backlight module, the light incident support comprises an aeration tank for dissipating heat generated from the light source, a sidewall and a connected bottom; and
wherein the light incident support is formed by extruded alumni.

9. The backlight module as claimed in claim 8, wherein the aeration tank is hollow rectangular-shaped or hollow bow-shaped, four sides of the aeration tank form a cavity, and two sides of the aeration tank communicate with the air outside the aeration tank.

10. A liquid crystal device comprises the liquid crystal panel and the backlight module as claimed in claim 8.
